(19) United States
(12) Patent Application Publication
(10) Pub. No.: US 2022/0087475 A1
(43) Pub. Date: Mar. 24, 2022

(54) Portable Charcoal Grill and Smoker

(71) Applicant: Masterbuilt Manufacturing, LLC, Columbus, GA (US)

(72) Inventors: Robert V. Terrell, Auburn, AL (US); Daniel Mercer, Hamilton, GA (US)

(73) Assignee: Masterbuilt Manufacturing, LLC, Columbus, GA (US)

(21) Appl. No.: 17/478,115

(22) Filed: Sep. 17, 2021

Related U.S. Application Data
(60) Provisional application No. 63/080,419, filed on Sep. 18, 2020.

(51) Int. Cl. A47J 37/07; A23B 4/052

(52) U.S. Cl. CPC A47J 37/0704; A47J 37/0786; A47J 2037/0777; A23B 4/052; A47J 37/0754

(57) ABSTRACT

The disclosed embodiments provide a portable charcoal grill and smoker that includes a lower body panel and a lid. A unitary body liner may be positioned within the lower body panel and configured to support a grill rack. The body liner may include a grease pan and a support well for a fuel basket. The fuel basket supports a fuel-grate assembly with a fuel grate which together form a hopper above the fuel grate. A variable-speed fan may be used to control an amount of combustion air that flows into the fuel basket and fuel-grate assembly and, thus, the amount of heat and smoke that is generated and distributed to a food product being cooked or smoked on the grill rack. A removable battery pack may be used to provide power to the fan.

### CROSS REFERENCE TO RELATED APPLICATION

The present application claims the benefit of priority under 35 U.S.C. § 119(e) to U.S. Provisional Application No. 63/080,419, entitled “Portable Gravity Fed Charcoal Grill,” filed Sep. 18, 2020, which is hereby incorporated by reference in its entirety as if fully set forth herein.

### FIELD OF THE INVENTION

The present invention generally relates to grills and smokers, and more particularly, to a portable charcoal grill and smoker having an internal fuel basket and fuel-grate assembly for convenient and efficient cooking and temperature control.

### BACKGROUND OF THE INVENTION

Traditional small charcoal grills include a grill rack for supporting the food to be cooked with charcoal distributed beneath the grill rack in a fire box or fire space. Such grills may or may not include a removable cover positioned above the grill rack to hold heat within the cooking space above the grill rack. Efficiently controlling the temperature and therefore the consistency of cooking using such grills is very difficult because it is dependent on a number of factors including the distribution of the charcoal in the fire box beneath the grill rack, the amount of charcoal loaded into the fire box, the settings of the vents for the grill cover, and the time/temperature curve for the burning charcoal. Consequently, inconsistent cooking may result from uncontrolled variations in those factors.

### SUMMARY OF THE INVENTION

A portable grill and smoker in accordance with the disclosed embodiments overcomes the disadvantages of the prior art by replacing the standard under-grill fire box with a fuel basket and fuel-grate assembly disposed within the cooking enclosure and to a side of the cooking area. The positioning allows for convenient loading and unloading of charcoal and ash while on the go and also permits effective temperature control when paired with other components as discussed below.

The portable grill and smoker also may comprise a fan (e.g., a variable speed fan) that can be controlled to provide different amounts of combustion air into the fuel basket, and thus to the fuel (such as charcoal) burning on the fuel grate within the fuel basket. The combustion air from the fan may be directed to flow through one or more openings in a first side wall of the fuel basket and into the interior of the fuel basket. After being heated by the burning fuel in the fuel basket, the resulting heated air and/or smoke may flow out of the fuel basket through one or more openings in a second side wall of the fuel basket and into an area of the portable grill and smoker located below a grill rack configured to support at least one food product being cooked or smoked. In some embodiments, a heat tent or manifold may be positioned outside of the fuel basket, under the grill rack, and substantially adjacent to the one or more openings in the second side wall of the fuel basket, so the heated air and smoke may flow out of the fuel basket and into an inlet of the heat tent or manifold. One or more openings along the length of the heat tent or manifold may be used to distribute the heated air and smoke substantially evenly in a heat distribution area located below the grill rack holding the at least one food product being cooked or smoked.

In the exemplary disclosed embodiments, the portable grill and smoker may comprise a lower body panel with end caps and a lid with end caps. The lid may be hinged to the lower body panel. In some embodiments, a battery pack and a controller configured to control the speed of the fan may be removably attached to the underside of the lower body panel. The battery pack may comprise a rechargeable battery or any other types of batteries. Alternatively, the battery pack may include a power adapter for direct connection to a standard electrical outlet.

A body liner may be supported within the interior of the lower body panel. The body liner preferably has a unitary construction formed of a single type of material, such as a metal. The body liner, in tum, may support the grill rack within the lower body panel. The body liner also may include a grease tray that extends beneath the grill rack to catch drippings from one or more food products being cooked on the grill rack. The grease tray may slope toward a grease drain where the grease can be collected in a grease cup slidably attached to the underside of the lower body panel. In accordance with the disclosed embodiments, one end of the body liner includes a fuel-basket well that is configured to support the fuel basket. That is, the fuel basket may be positioned in the fuel-basket well portion of the body liner. The fuel basket may be configured to support the fuel-grate assembly within an interior of the fuel basket.

Further to the disclosed embodiments, the fuel basket may have two opposing sides, each with a substantially vertical upper portion coupled to a lower slanted portion, e.g., slanting toward a middle section of the fuel basket. In addition, the fuel basket may have two opposing ends. In the disclosed embodiments, a first end of the fuel basket may comprise a first side wall with one or more combustion-air openings for receiving combustion air from the fan. The opposing second end of the fuel basket may comprise a second side wall with one or more air openings substantially adjacent to the grease tray in the body liner to allow heated air and smoke to enter into the interior of the body liner below the grill rack.

In some disclosed embodiments, a heat tent with a V-shaped top, a substantially flat floor, and one or more side openings, may extend along the length of the grease tray in the body liner and may be configured to distribute heated air and smoke received from the one or more air openings in the second side wall of the fuel basket to an area under the grill rack. In some embodiments, for example, the heat tent is configured to distribute the heated gases evenly through its one or more side openings into a lower heat-distribution area below the grill rack.

The fuel-grate assembly may be nested within the fuel basket. The fuel-grate assembly includes a substantially flat fuel grate for supporting the burning fuel, such as charcoal for generating heat and/or wood for generating smoke. Substantially vertically extending standoffs on opposing ends of the fuel-grate assembly may extend below the fuel grate and support the fuel grate above the bottom of the fuel basket to create an ash collector. In operation, as the fuel burns and ashes form on top of the elevated fuel grate, the ashes may fall through the fuel grate into an ash collector portion of the fuel basket below. The sides of the fuel-grate assembly preferably conform to the shapes of the slanted sides of the fuel basket, and together with the first and second ends of the fuel basket, form a hopper for holding fuel on and above the fuel grate. In some embodiments, the hopper may be filled with charcoal and/or wood. Further, in certain embodiments, a lid can cover the hopper.

As the fuel on the fuel grate bums while cooking or smoking food in the portable grill and smoker of the disclosed embodiments, the generated ashes drop through the fuel grate into the ash collector, and additional fuel in the hopper above the fuel grate can descend under the influence of gravity onto the fuel grate for replenishing the burning fuel. In some embodiments, the speed of the fan controls the amount of combustion air that is provided to the burning fuel in the fuel basket, thereby adjusting the temperature of the fire and the amount of heat supplied through the one or more air openings in the second end of the fuel basket, to the heat tent, and ultimately to the food product(s) on the grill rack.

In some embodiments, a controller coupled to the portable grill and smoker may be configured to receive a cooking temperature input from the user, monitor the temperature in the interior of the body liner by means of at least one temperature sensor, and control a speed of the fan to thereby control the amount of combustion air forced into the fuel basket. The fan also may be interlocked with a lid of the grill and/or a lid of the fuel basket so the fan is turned off if a lid has been opened. At the end of the cooking or smoking process, the user may use the controller to turn up the temperature (e.g., by increasing the fan speed) to allow the fuel to burn out in the fuel basket.

The controller may comprise an oil capillary tube that controls an electronic switch configured to turn on and off the fan. For example, the oil capillary tube may be positioned within the portable grill and smoker and may be configured to close the electronic switch, thus turning on the fan, when the temperature in the grill and smoker is below a certain threshold temperature. Similarly, the oil capillary tube may be configured to open the electronic switch, thus turning off the fan, when the temperature in the grill and smoker exceeds the threshold temperature. The controller could also comprise or control other types of electronic switches, relays, or other controllers for turning on and off the fan.

In some embodiments, the controller may comprise a hardware module or other control unit that is either permanently or removably attached to the portable grill and smoker. The controller may comprise a control panel with one or more user-interface elements, such as hardware and/or software components, that allow a user to select a desired cooking or smoking temperature. In some embodiments, the controller may include a display unit, which may comprise a touch screen. In some embodiments, the control panel may be integrated with the controller or otherwise coupled to the controller.

The controller may be configured to communicate with one or more remote devices (such as phones, tablets, laptops, desktops, wearable devices, or any other user devices) over wireless connections. In such embodiments, the user may input information to send to the controller using an application executing on a mobile device. The mobile device may transmit this user-inputted information to the control unit over a direct wireless link (such as using Bluetooth or another peer-to-peer wireless protocol) or, alternatively, through a wireless network (such as an 802.11 wireless network) to which both the controller and mobile device are connected. The controller may be configured to transmit information back to the mobile device for display to the user. In some embodiments, the controller unit also may be configured to communicate information over a wireless network to one or more remote computers, for example, in a cloud-computing platform. For example, the controller may transmit information about the portable grill and smoker to a cloud service and/or receive recommendations or instructions from the cloud service, for instance, about how to optimize control of the fan speed for precisely controlling the temperature inside the portable grill and smoker.

The present disclosure is merely exemplary of certain embodiments of the present invention. Further objects, features, and advantages will become apparent upon consideration of the following detailed description of the exemplary embodiments when taken in conjunction with the drawings and the appended claims.

### BRIEF DESCRIPTION OF THE DRAWINGS

The particular features and advantages of the invention will become apparent from the following description taken in connection with the accompanying drawings in which like reference numbers indicate identical or functionally similar elements. The following figures depict details of disclosed embodiments. The invention is not limited to the precise arrangement shown in these figures, as the accompanying drawings are provided merely as examples.

FIG. 1 is a perspective view of an exemplary portable charcoal grill and smoker with an auxiliary cart in accordance with certain embodiments of the present invention.

FIG. 2 is a front perspective view of the exemplary portable charcoal grill and smoker in accordance with certain embodiments of the present invention.

FIG. 3 is a bottom perspective view of the exemplary portable charcoal grill and smoker in accordance with certain embodiments of the present invention.

FIG. 4 is a front elevation view of the exemplary portable charcoal grill and smoker in accordance with certain embodiments of the present invention.

FIG. 5 is a right side elevation view of the exemplary portable charcoal grill and smoker in accordance with certain embodiments of the present invention.

FIG. 6 is a back elevation view of the exemplary portable charcoal grill and smoker accordance with certain embodiments of the present invention.

FIG. 7 is a left side elevation view of the exemplary portable charcoal grill and smoker in accordance with certain embodiments of the present invention.

FIG. 8 is a top plan section view of the exemplary portable charcoal grill and smoker in accordance with certain embodiments of the present invention.

FIG. 9 is a bottom plan view of the exemplary portable charcoal grill and smoker in accordance with certain embodiments of the present invention.

FIG. 10 is a left side perspective of the exemplary portable charcoal grill and smoker with the left lower body end cap and the left lid end cap removed to expose internal detail in accordance with certain embodiments of the present invention.

FIG. 11 is a front perspective view of the exemplary portable charcoal grill and smoker with the lid removed to expose internal detail in accordance with certain embodiments of the present invention.

FIG. 12 is a front perspective view of the exemplary portable charcoal grill and smoker with the lid and the grill rack removed to expose internal detail in accordance with certain embodiments of the present invention.

FIG. 13 is a front perspective view of the exemplary portable charcoal grill and smoker with the lid, the grill rack, and the heat tent removed to expose internal detail in accordance with certain embodiments of the present invention.

FIG. 14 is a front perspective view of the exemplary portable charcoal grill and smoker with the lid, the grill rack, the heat tent, heat tent floor, and the charcoal basket lid removed to expose internal detail in accordance with certain embodiments of the present invention.

FIG. 15 is a front perspective view of the exemplary portable charcoal grill and smoker with the lid, the grill rack, the heat tent, the heat tent floor, the charcoal basket lid, and the charcoal grate assembly removed to expose internal detail in accordance with certain embodiments of the present invention.

FIG. 16 is a front perspective view of the exemplary portable charcoal grill and smoker with the lid, the grill rack, the heat tent, the heat tent floor, the charcoal basket lid, the charcoal grate assembly, and the charcoal basket removed to expose internal detail in accordance with certain embodiments of the present invention.

FIG. 17 is a left side perspective view of the lower body panel and the body liner, with the lower body end cap removed, of the exemplary portable charcoal grill and smoker in accordance with certain embodiments of the present invention.

FIG. 18 is a right side elevation view of the body liner of the exemplary portable charcoal grill and smoker in accordance with certain embodiments of the present invention.

FIG. 19 is a front perspective view of the body liner of the exemplary portable charcoal grill and smoker in accordance with certain embodiments of the present invention.

FIG. 20 is a front perspective section view of the heat tent of the exemplary portable charcoal grill and smoker in accordance with certain embodiments of the present invention.

FIG. 21 is an exploded perspective view of the charcoal basket and charcoal grate assembly of the exemplary portable charcoal grill and smoker in accordance with certain embodiments of the present invention.

FIG. 22 is a schematic diagram illustrating an exemplary network architecture in which the exemplary portable charcoal grill and smoker may be configured to wirelessly communicate with a user device and also wirelessly communicate via a network with one or more remote computers, for example that provide a cloud service in a cloud computing platform, in accordance with certain embodiments of the present invention.

### DETAILED DESCRIPTION OF THE DISCLOSED EMBODIMENTS

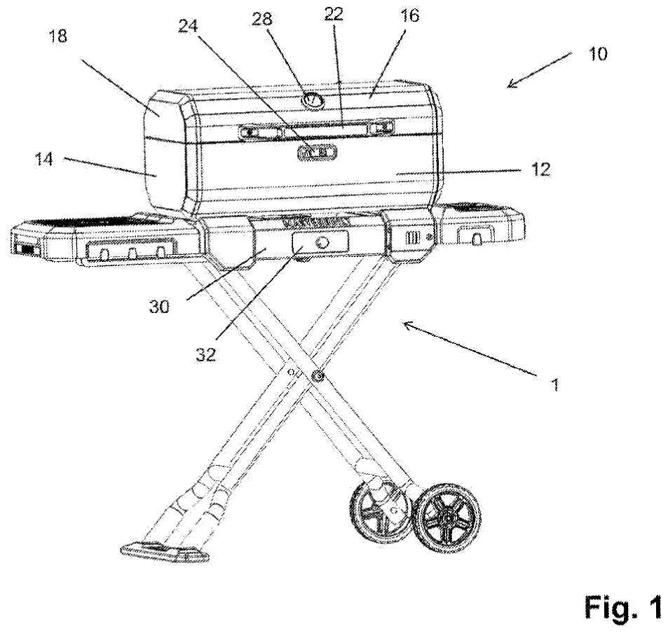

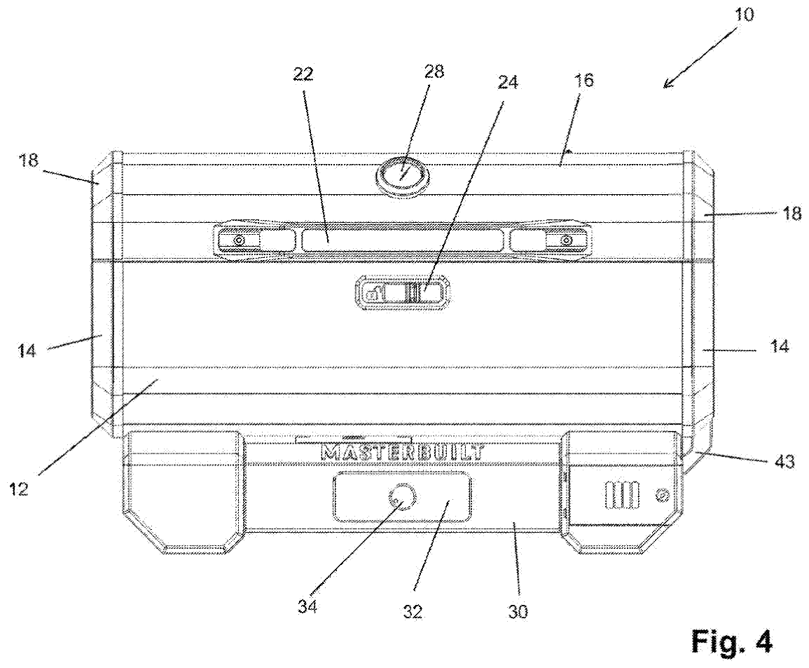

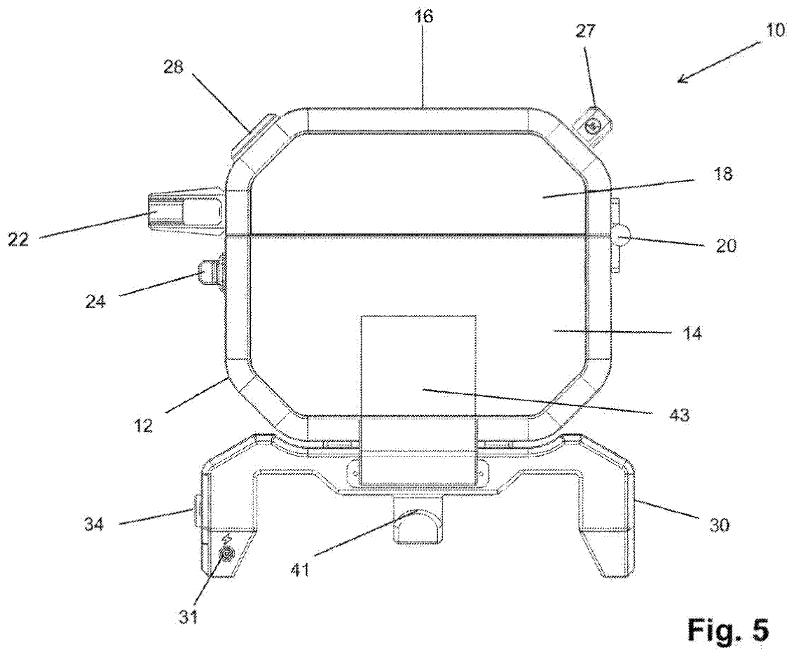

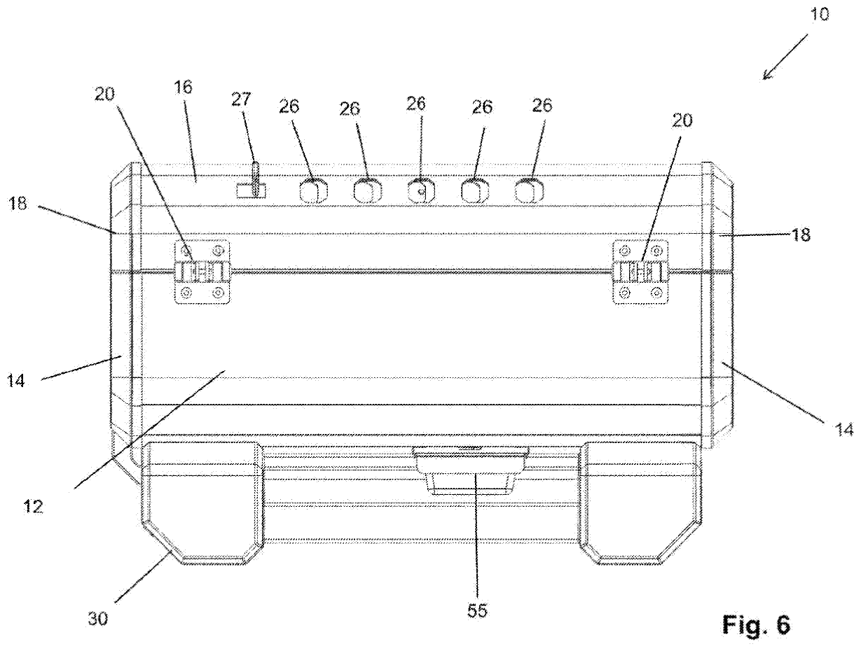

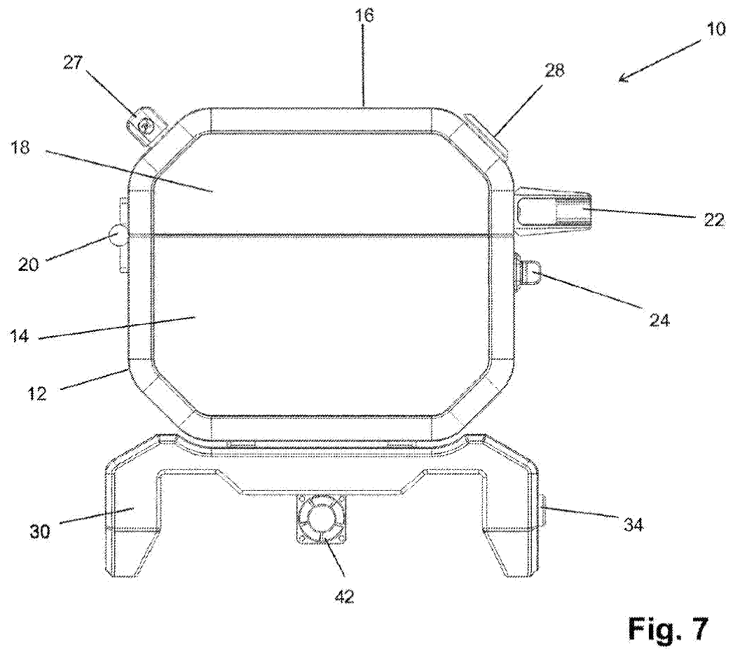

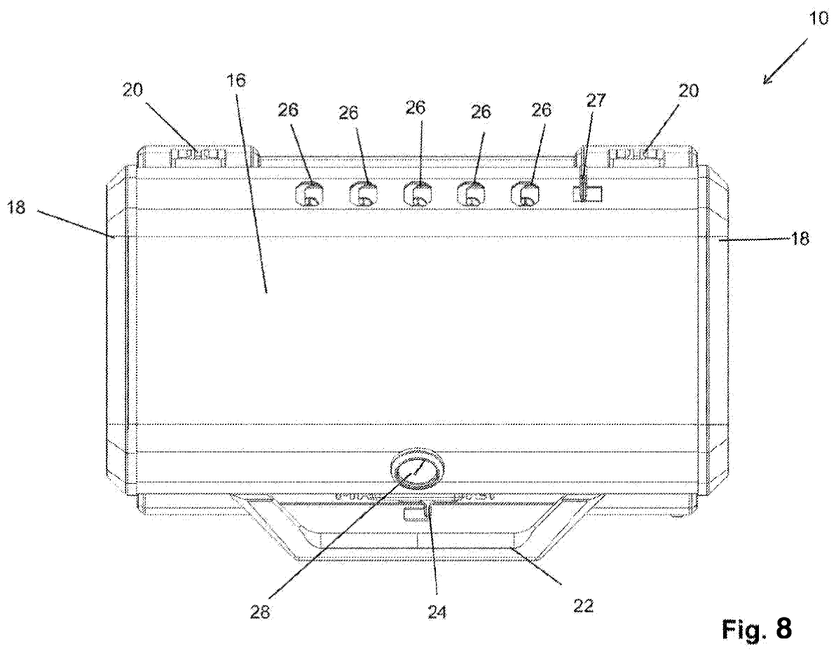

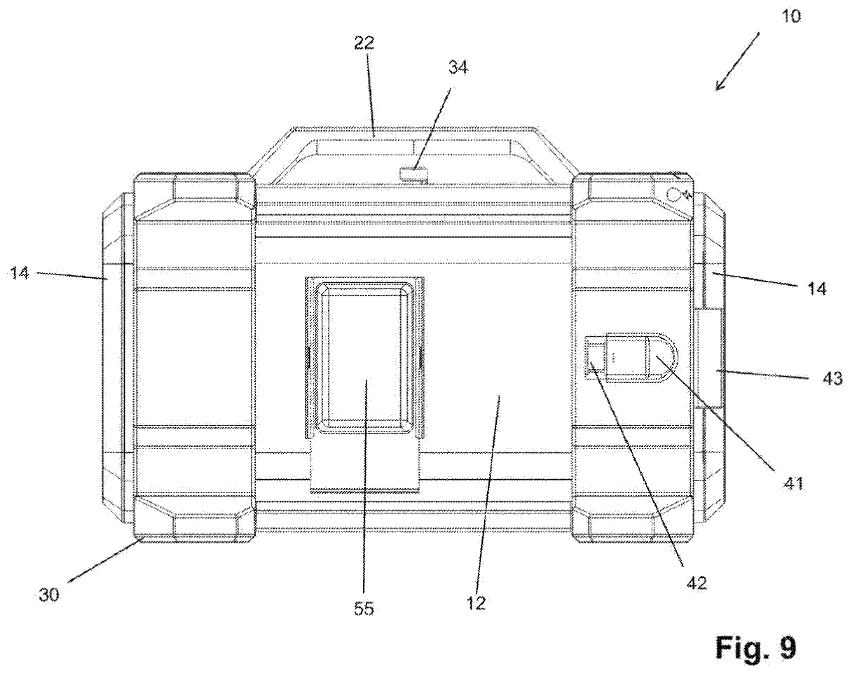

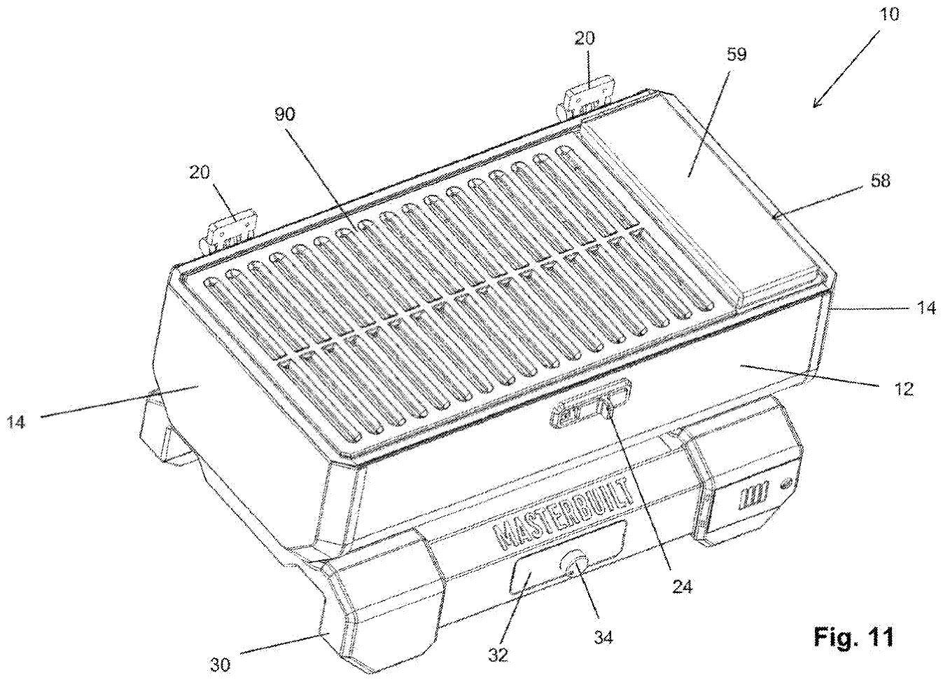

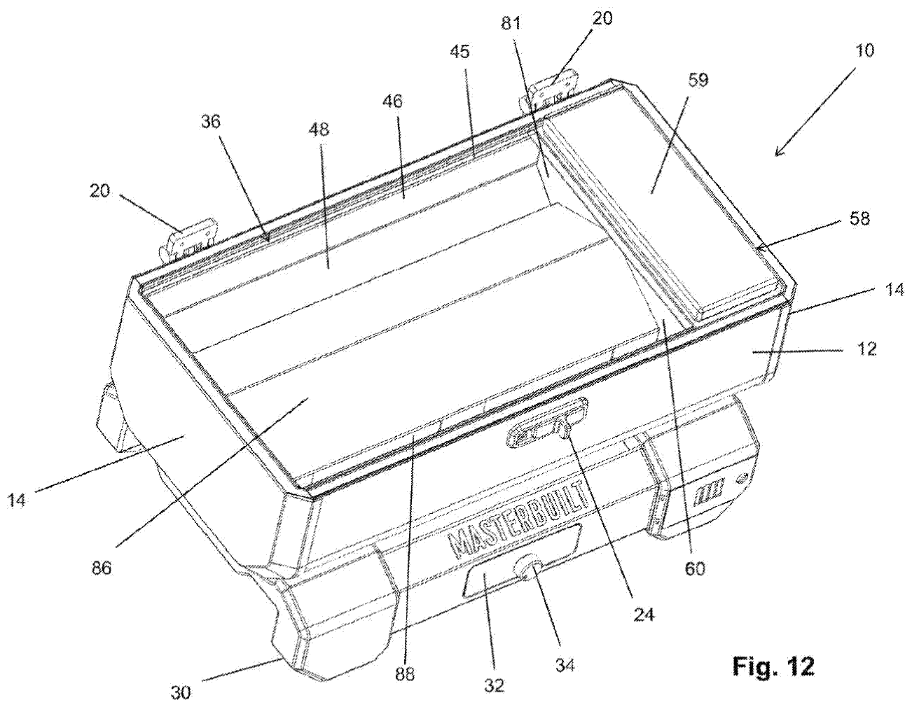

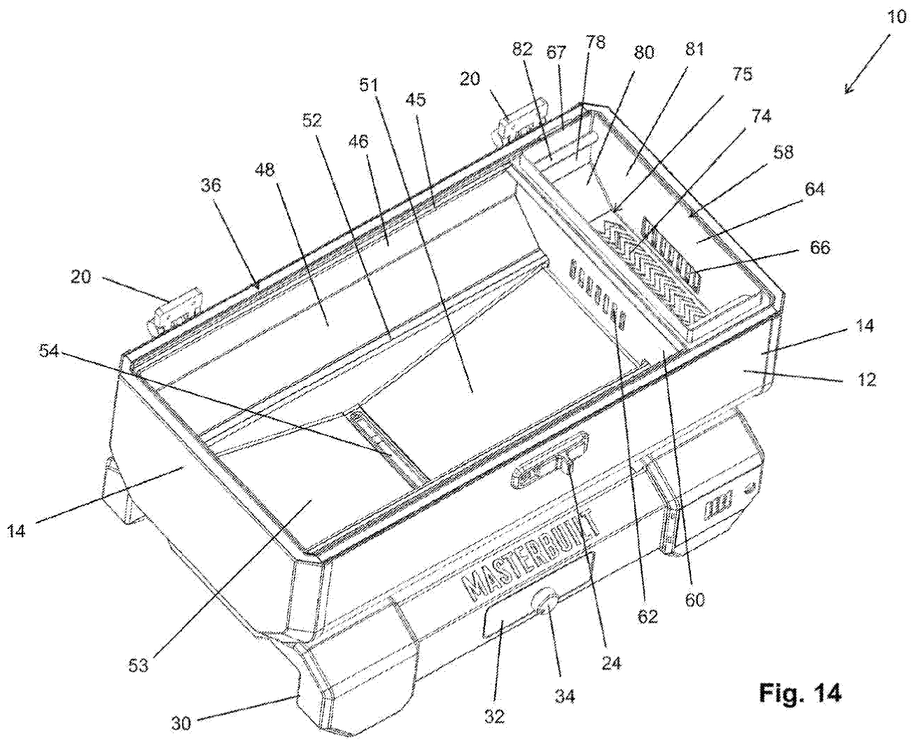

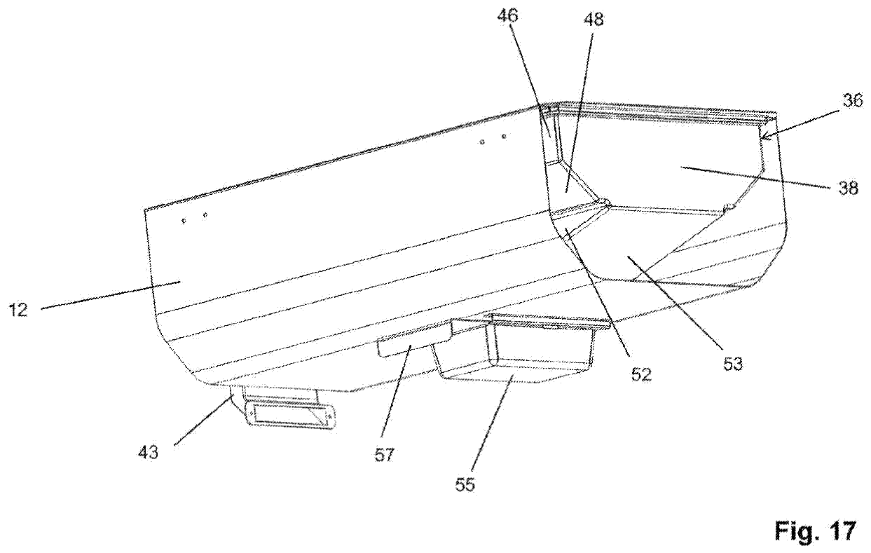

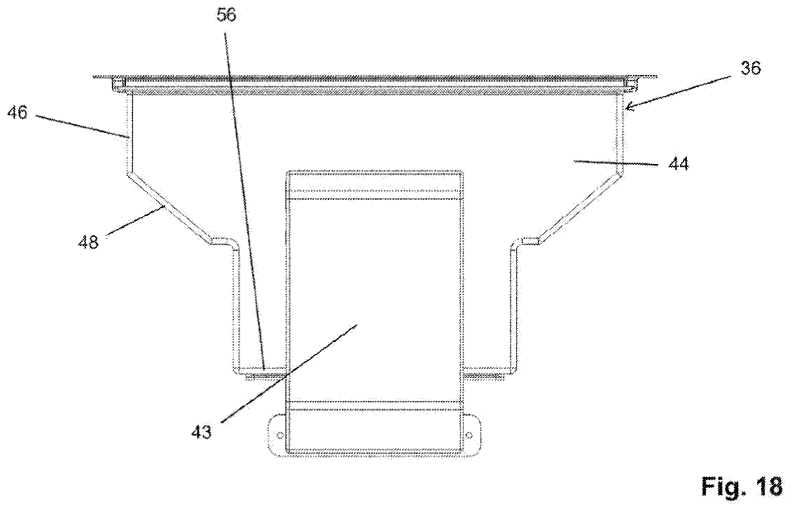

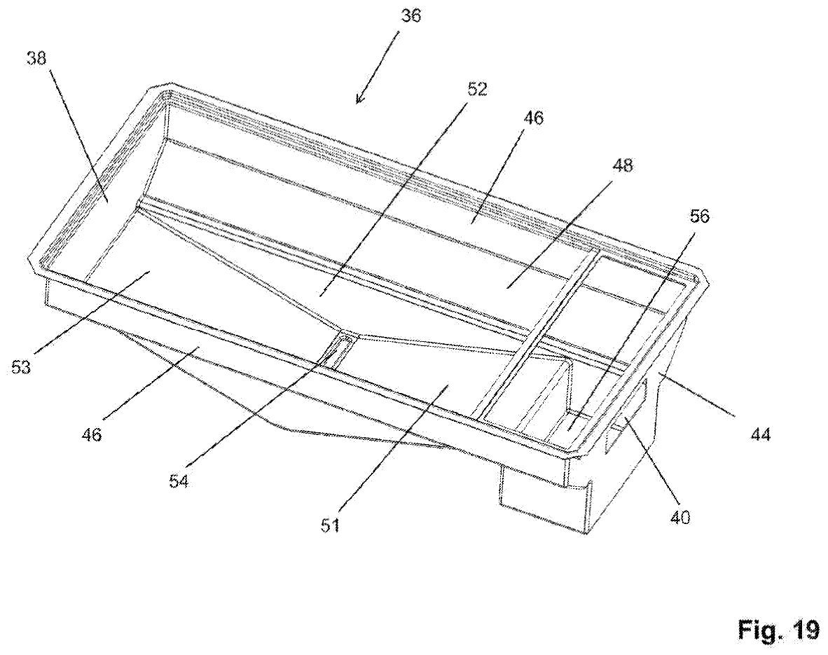

FIGS. 1-21 show various views of an exemplary portable charcoal grill and smoker 10 that may be used in accordance with certain disclosed embodiments of the invention. For example, FIG. 1 shows the portable charcoal grill and smoker 10 may be mounted on a cart 1 for use in transporting the grill and smoker and supporting the grill and smoker at a convenient height for use. In some embodiments, the cart 1 may be collapsible, such that the portable charcoal grill and smoker 10 may be removed from the cart and then the cart may be collapsed into a more convenient form for storage when not in use.

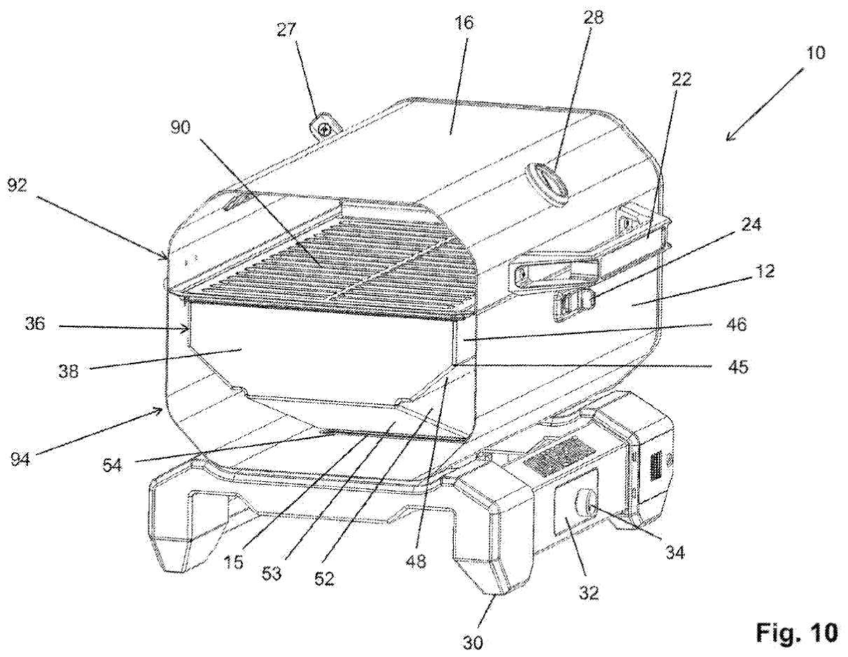

The portable grill and smoker 10 may include a lower body panel 12 with end caps 14 and a lid 16 with end caps 18. Hinges 20 connect the lower body panel 12 to the lid 16 allowing the lid 16 to be opened and closed. The lid 16 includes a lid lock 24 that secures the lid 16 to the lower body panel 12 when the lid 16 is in the closed position. The lid 16 also may include a handle 22 for opening the lid 16 and for carrying the portable grill and smoker 10. A temperature gauge 28 may be mounted in the upper portion of the lid 16 to allow a user to monitor a temperature within a cooking space 92 (FIG. 10) between the lid 16 and a grill rack 90. The temperature displayed by the gauge 28 may be measured by a temperature sensor (not shown) also mounted on the upper portion of the lid 16 or elsewhere within the grill and smoker. The lid 16 also may include one or more exhaust vents 26 or a similar damper mechanism configured to allow for the escape of heat and smoke from the cooking space 92. The exhaust vents 26 may be opened and closed by means of an exhaust slide 27 or other adjustable means for selectively opening and closing the vents 26 or otherwise adjusting the sizes of their vent openings. By adjusting the position of the exhaust slide 27, the user can further control the temperature within the cooking space 92.

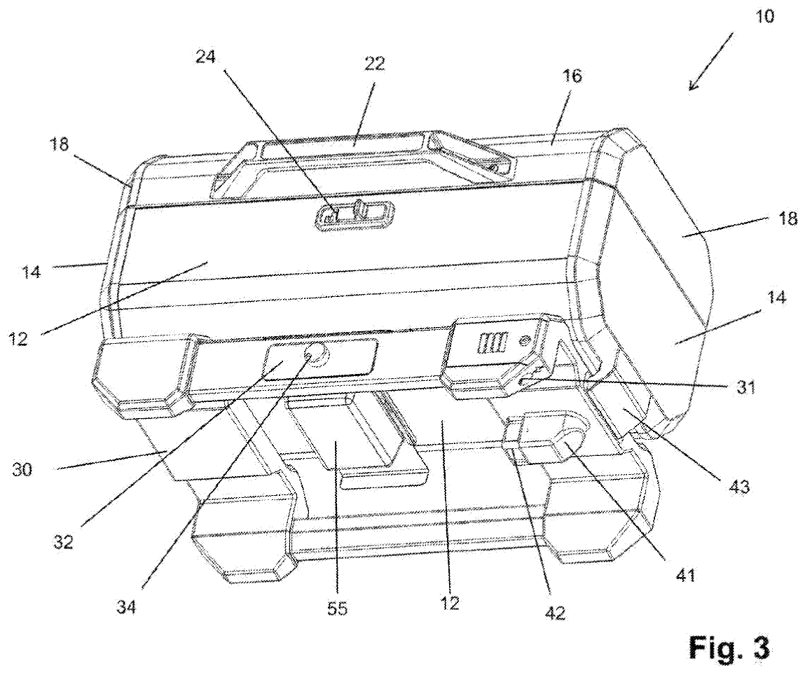

With reference to FIGS. 10-18, a unitary body liner 36 is supported within the lower body panel 12. The body liner 36 in turn comprises one or more supports on which the grill rack 90 may be mounted and supported. The unitary body liner 36 may include a left end 38, a right end 44, sides 45 with upper vertical portions 46, and slanted lower portions 48. The lower portions 48 converge toward a grease tray 52. The grease tray 52 extends beneath the grill rack 90 and is configured to catch drippings from the food product(s) being cooked or smoked on the grill rack 90. In the disclosed embodiments, the grease tray 52 has a left sloping panel 53 and a right sloping panel 51 that converge toward a grease drain 54 positioned at or near the longitudinal center of the grease tray 52. The grease drain 54 may be aligned with a grease opening 15 in the lower body panel 12 to allow grease to be collected in a grease cup 55 slidably attached to the underside of the lower body panel 12 (FIG. 3). A grease cup handle 57 facilitates installation and removal of the grease cup 55 for emptying.

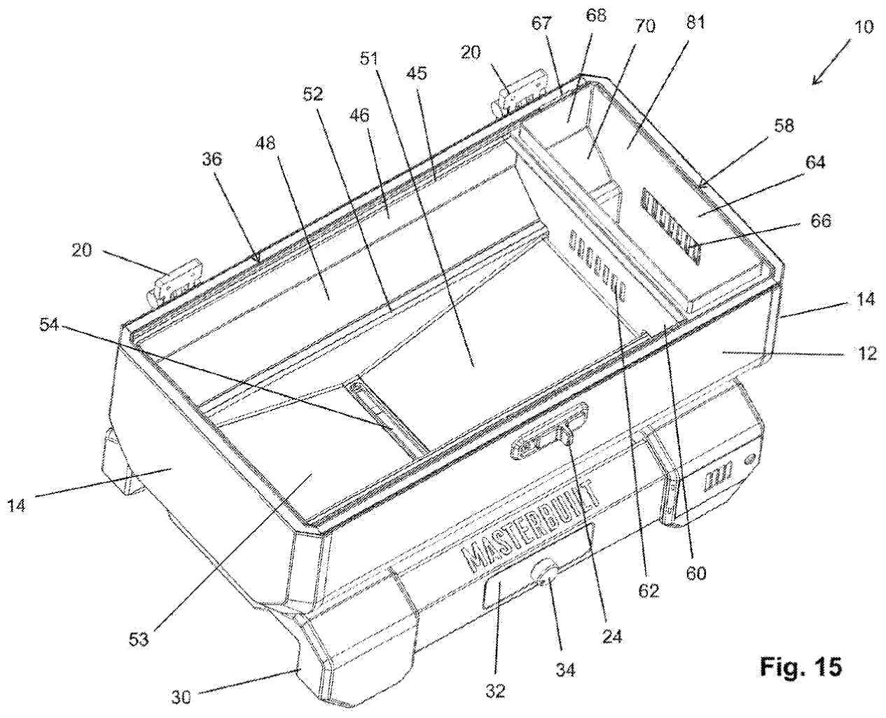

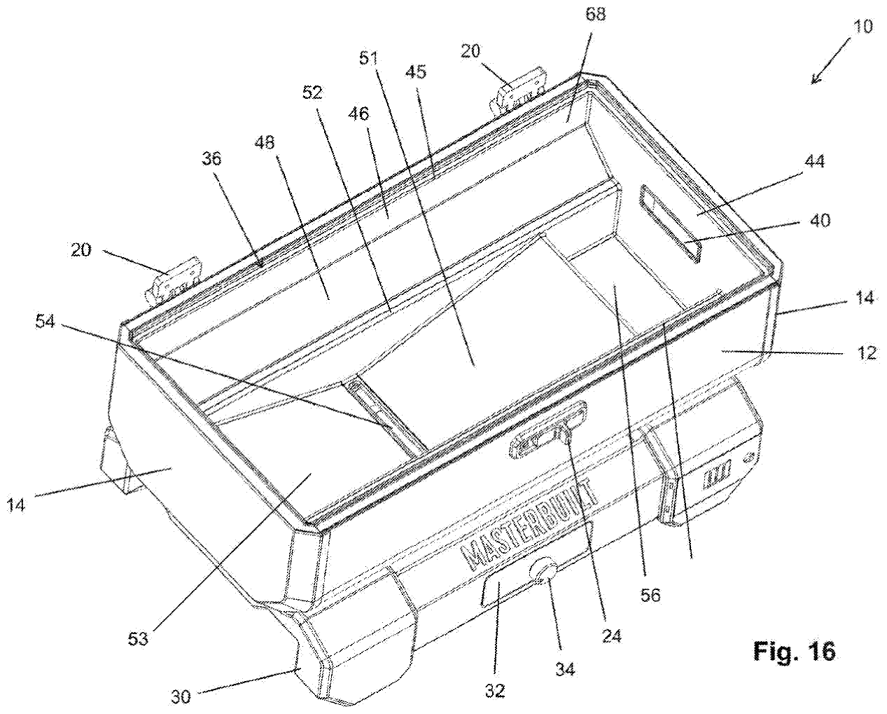

The right end 44 of the body liner 36 may include a fuel basket support well 56 (FIG. 16) for supporting the fuel basket 58. The right end 44 of the body liner 36 further includes an opening 40 that aligns with an upper air duct 43 that delivers combustion air from a fan 42 into the body liner 36 and thus into the fuel basket 58 through openings 66 (FIG. 15).

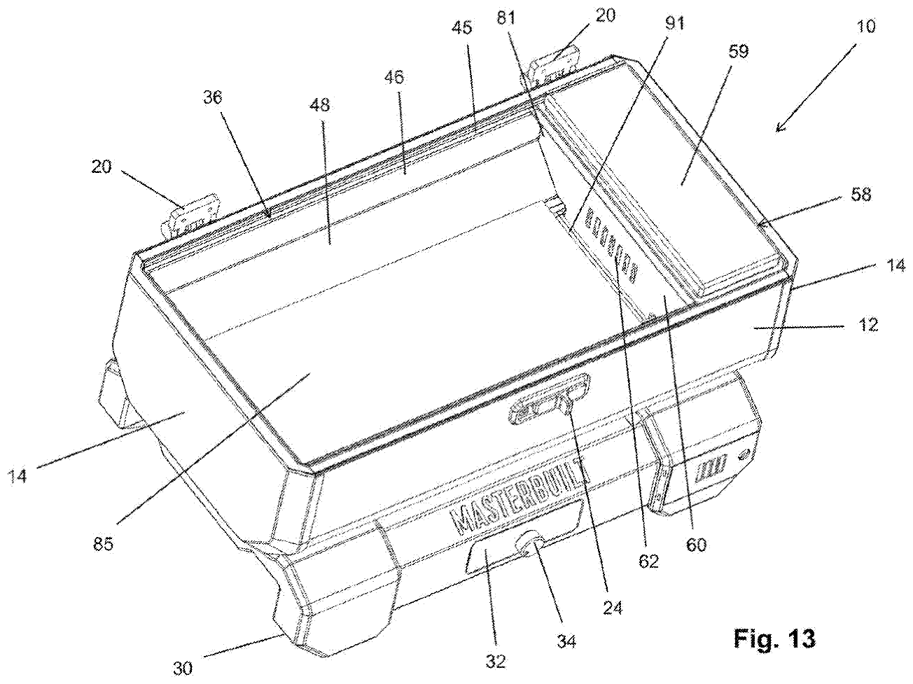

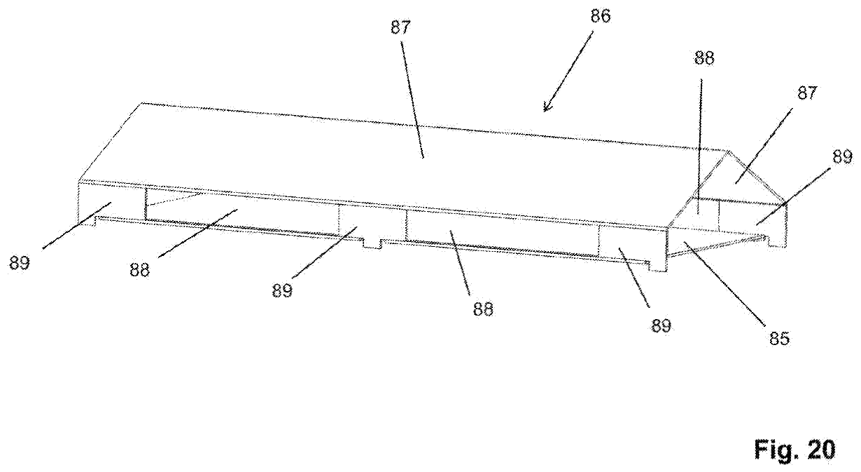

In the disclosed embodiments, the fuel basket 58 has two sides 67, each with an upper vertical portion 68 and a lower slanted converging portion 70 (FIGS. 15 and 20). The right end 64 of the fuel basket 58 has first side wall with combustion-air openings 66 for the admission of combustion air from the upper air duct 43 and into the fuel basket 58. The left end 60 of the fuel basket 58 has a second side wall with hot gas openings 62 for delivery of heated gases and smoke into a lower heat-distribution area 94 below the grill rack 90. In accordance with the disclosed embodiments, a heat tent 86 may comprise a V-shaped slanted top 87, a floor 85, and one or more side openings 88 that extend along the length of the grease tray 52 and distributes the heated gases and smoke substantially evenly through the side openings 88 to the lower space 94 below the grill rack 90. The drippings from the grill rack 90 may fall onto the slanted top 87 of the tent 86 and may run onto the floor 85 of the tent 86. The drippings then flow to either end of the floor 85 and are dropped into the grease tray 52 through openings 91 at each end of the floor 85 (FIG. 13).

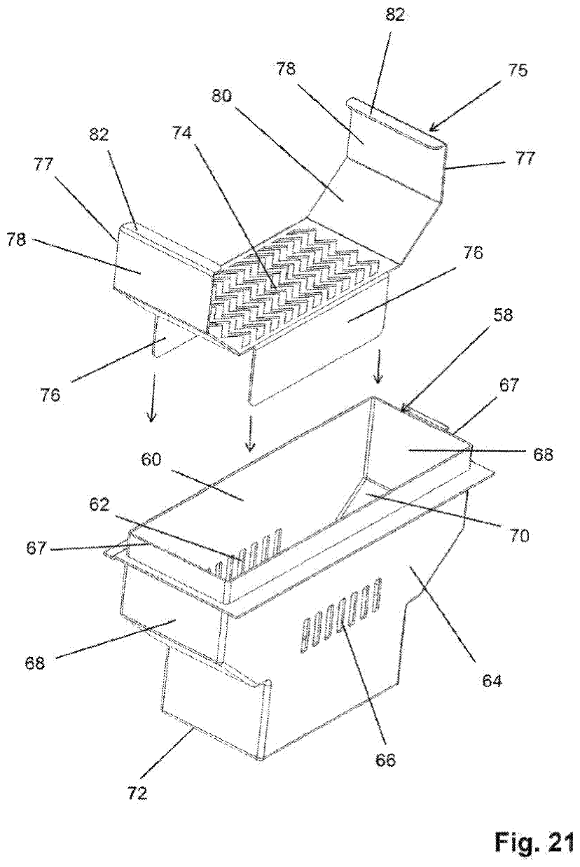

A fuel-grate assembly 75 may be nested within the fuel basket 58 (FIG. 21). The fuel-grate assembly 75 may include a fuel grate 74 for supporting the burning fuel, such as charcoal and/or wood. Standoffs 76 on either end of the fuel-grate assembly 75 may extend below the fuel grate 74 and support the fuel grate 74 above the bottom 72 of the fuel basket 58 to create an ash collector 72. The sides 77 of the fuel-grate assembly 75 each may comprise an upper vertical portion 78 and a lower slanted converging portion 80. The shapes of the sides 77 of the fuel-grate assembly 75 may conform to the shapes of the sides 67 of the fuel basket 58, and together with the ends 60 and 64 of the fuel basket 58, they collectively form a hopper 81 for holding fuel above the fuel grate 74. The hopper 81 may be filled with charcoal, wood, or any other solid fuel, and a lid 59 may be used to cover the hopper 81. In some embodiments, one or more supports 82 may be formed or attached at the top of the sides 78 to support a lid 59 over the hopper 81.

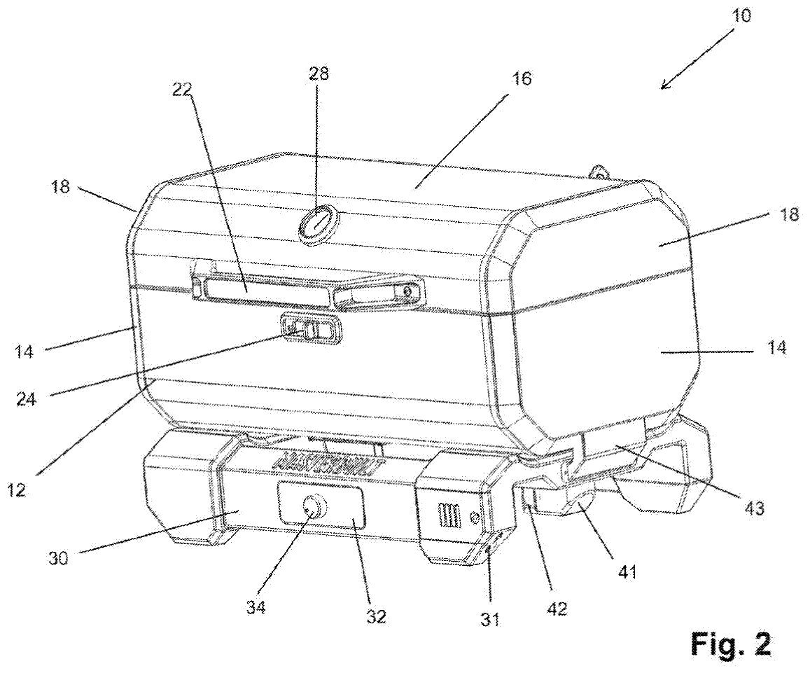

A battery pack 30 may be removably attached to the lower body panel 12. The battery pack 30 may have a rechargeable battery (not shown) with a charging port 31. Alternatively, the battery pack 30 may employ conventional batteries (not shown). Further, the battery pack 30 may include a power adapter (not shown) for direct connection to a standard electrical outlet. The battery pack 30 provides power to the fan 42, which may be mounted beneath the battery pack 30 as seen in FIGS. 2 and 3. The fan 42 is configured to deliver combustion air to the fuel basket 58 and fuel-grate assembly 75 through a lower air duct 41, the upper air duct 43, the opening 40 in unitary body liner 36, and one or more openings 66 in the fuel basket 58. The battery pack 30 further may include a control panel 32 with a speed control 34 that allows the user to control the speed of the fan 42 and thereby control the amount of combustion air delivered to the fuel basket 58 and the fuel-grate assembly 75. The control panel 32 may comprise a controller, such as one or more physical processors, configured to control the speed of the fan 42 based on input received via one or more user-interface elements (such as but not limited to speed control 34) on the control panel 32 or based on information received over a wireless link. Thus, control panel 32 also may be referred to herein as controller 32. In alternative embodiments, the controller configured to control the speed of the fan 42 may be a hardware module that is separate from the control panel 32 and may be coupled to the control panel 32, e.g., over a wired or wireless connection. In yet other alternative embodiments, the control panel 32 may be a hardware module that is also separate from the battery pack 30 on the portable grill and smoker 10.

As the fuel (such as charcoal) on the fuel grate 74 burns, the generated ashes may drop through the fuel grate 74 into the ash collector 72. Additional fuel in the hopper 81 above the fuel grate 74 may descend under the influence of gravity onto the fuel grate 74 for replenishing the fire. The speed of the fan 42 may be used to control the amount of combustion air fed through opening 40 in the right end 44 of the body liner 36 and through the openings 66 in the fuel basket 58 to the burning fuel, thereby adjusting the temperature of the fire and the amount of heat and/or smoke supplied through the heated air openings 62 in the left end of the 60 of the fuel basket 58 and to the grill rack 90.

As noted above, the controller 32 may comprise one or more physical processors, such as a microprocessor, microcontroller, digital signal processor, field programmable gate array, application specific integrated circuit, or the like, and may further include at least one non-transitory memory device for storing associated software or firmware, configured to control at least some operations of the one or more physical processors in accordance with the disclosed embodiments described herein. The controller 32 also comprises a plurality of input/output (“I/O”) connections, for example interconnected with the one or more physical processors by a system bus, for communicating with other components in the portable grill and smoker 10. The controller 32 may, among other things, receive various user inputs and sensor signals and transmit control signals to the fan 42, or a separate fan controller (not shown) coupled to the fan 42, and other components in accordance with the disclosed embodiments described herein.

More generally, a controller 32 in the portable grill and smoker 10 may be configured to control the fan speed, and thus the temperature inside the cooking space 92 between the lid 16 and the grill rack 90, using any known control technique, including but not limited to closed-loop control using one or more temperature-measurement signals, e.g., from a temperature sensor. The controller may include at least one processor and a memory that stores computer-executable instructions that, when executed by the at least one processor, comprises a software program that implements an appropriate control algorithm based on various sensor measurements received by the controller, such as from one or more ambient-air temperature sensors and/or meat-probe temperature sensors.

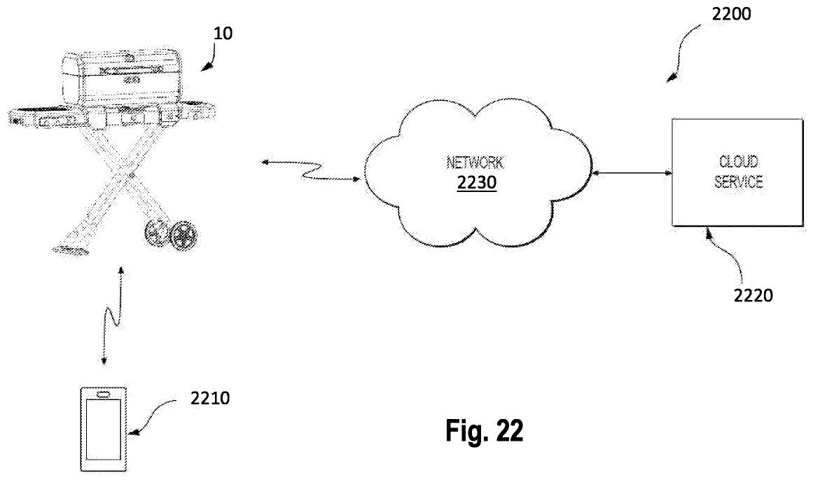

In some embodiments, the controller 32 also may have additional functions, such as receiving user input from one or more user-interface elements and/or communicating with a remote user device or remote computer as discussed further below with reference to FIG. 22. The controller 32 may include a display (not shown) for displaying temperature measurements or other information to the user. In some embodiments, the display may be a touch screen through which the user can input information, such as a target temperature.

The controller 32 may comprise at least one wireless transceiver configured to wirelessly communicate with one or more remote devices using any conventional wireless protocols, such as Bluetooth, ZigBee, or other protocols known in the art. The controller 32 also may include a wireless transceiver configured to communicate with over an IEEE 802.11 (“Wi-Fi”) network, a cellular network, or any other wireless network. Those skilled in the art will appreciate each wireless transceiver in the controller is coupled to one or more respective antennas and other transmitter and receiver circuitry required to effect wireless communications. In some embodiments, the at least one wireless transceiver may be further configured to wirelessly communicate with the fan 42 or a fan controller (not shown) coupled to the fan 42. In some embodiments, the controller 32 also may be connected over wired connections to one or more sensors (e.g., one or more meat probes or temperature sensors), the fan 42, or other components in the portable grill and smoker 10, depending on the controller's relative proximity to those components.

FIG. 22 is a schematic diagram illustrating an exemplary network architecture 2200 in which the portable grill and smoker 10 may be configured to wirelessly communicate with a user device 2210 and also may be configured to wirelessly communicate via a network 2230 with one or more remote computers that provide a cloud service 2220 in a cloud computing platform in accordance with certain disclosed embodiments. For example, the user may have a mobile device, such as a smartphone, tablet, laptop, or other user equipment, or another type of remote device, such as a desktop or appliance, that can establish a wireless connection with the controller of the portable grill and smoker 10. The user device 2210 may be configured to communicate with the controller over a peer-to-peer wireless connection, such as over a Bluetooth connection, or over a local area network, such as a Wi-Fi network.

The controller also may establish a network connection with one or more remote servers through a network 2230, which may be a public network such as the Internet. For example, the controller may be configured to communicate packet-based information with one or more remote servers using Internet protocols, such as HTTP and TCP/IP. In some embodiments, the controller preferably accesses at least one cloud-based service 2220 on the one or more remote servers through the network 2230. The cloud-based service 2220 may provide certain database services for managing data collected by sensors in the portable grill and smoker 10 and other information generated or collected by the controller or other components in the portable grill and smoker 10. In addition, the cloud-based service 2220 may provide data, commands, and/or instructions to the controller, for example, that may be used by the controller to implement a strategy for controlling an amount of air flow into the fuel basket 58 and fuel-grate assembly 75 by controlling a speed of the fan 42.

In some embodiments, the controller may be configured to receive user inputs from the user device 2210 rather than from the control panel 32. For example, the user device 2210 may execute an application that provides a user interface which allows the user to input selections, for example, for setting a target temperature inside the cooking space 92. The user device 2210 may be configured to transmit such user inputs over the wireless connection to the controller, which processes the received user inputs in the same way as it would if they had been received directly from user-interface elements on the control panel 32. For example, the user may select a target temperature for the cooking space 92 using the application on the user device 2210, then the user device 2210 may send the user's selected target temperature to the controller over a Bluetooth connection or a Wi-Fi network.

Those skilled in the art will also appreciate that other modifications and alternatives may be implemented in accordance with the exemplary embodiments described herein. For example, the controller may have other functionality in addition to those exemplary processes and components described herein. For instance, it will be apparent to those skilled in the art that various processor and memory types, including various computer-readable media, may be used, for example to implement the controller, to store and execute program instructions pertaining to the techniques described herein. In other embodiments, the controller may be responsive to touch or voice commands, or receive instructions through an integrated cloud-based voice program (e.g., Amazon Alexa, Google Assistant, Microsoft Cortana, or Apple Siri).

While this invention has been described with reference to preferred embodiments thereof, it is to be understood that variations and modifications can be affected within the spirit and scope of the invention as described herein and as described in the appended claims. Accordingly, this description is to be taken only by way of example and not to otherwise limit the scope of the exemplary disclosed embodiments herein. Therefore, it is the object of the appended claims to cover all such variations and modifications as come within the true spirit and scope of the embodiments disclosed herein.

We claim:

1. A portable grill and smoker, comprising:
a lower body comprising a grill rack;
a body liner configured to fit within an interior of the lower body, the body liner comprising a fuel-basket well located to a side of the grill rack;
a fuel basket configured to fit within the fuel-basket well; and
a fuel-grate assembly configured to fit within the fuel basket, the fuel-grate assembly comprising a fuel grate configured to hold fuel for generating at least one of heat or smoke in the portable grill and smoker,
wherein the fuel basket and the fuel-grate assembly together form a hopper above the fuel grate and an ash collector below the fuel grate.

2. The portable grill and smoker of claim 1, wherein the body liner comprises one or more supports that are configured to support the grill rack above a temperature distribution area below the grill rack.

3. The portable grill and smoker of claim 2, further comprising a fan configured to provide both combustion air to the fuel grate and at least one of heated air or smoke to the temperature distribution area below the grill rack.

4. The portable grill and smoker of claim 3, further comprising a controller configured to control a speed of the fan.

5. The portable grill and smoker of claim 3, further comprising a battery pack for operating the fan.

6. The portable grill and smoker of claim 2, further comprising a one or more openings disposed in a side wall of the fuel basket, wherein the one or more openings are configured to deliver at least one of heated air or smoke to the heat distribution area below the grill rack.

7. The portable grill and smoker of claim 6, further comprising a manifold disposed within the heat distribution area below the grill rack, wherein the manifold comprises an inlet configured to receive the at least one of heated air or smoke from the one or more openings in the side wall of fuel basket and is further configured to distribute the received heated air or smoke to the grill rack.

8. The portable grill and smoker of claim 7, wherein the manifold comprises a V-shaped top, a substantially flat floor, and one or more side openings.

9. The portable grill and smoker of claim 1, further comprising a lid hingedly connected to the lower body.

10. The portable grill and smoker of claim 1, further comprising a lid configured to cover the hopper.

11. The portable grill and smoker of claim 1, further comprising a grease pan configured to direct grease into a removable grease cup.

12. The portable grill and smoker of claim 1, wherein the portable grill and smoker is mounted on a collapsible cart.

13. A portable grill and smoker, comprising:
a lower body;
a grill rack disposed above a heat distribution area within the lower body;
a hopper configured to receive fuel and disposed within the lower body in an area positioned at a side of both the grill rack and the heat distribution area, the hopper comprising a first side wall comprising an air inlet and a second side wall comprising an air outlet;
a fan configured to provide air to the air inlet of the hopper; and
a manifold disposed within the heat distribution area, the manifold configured to receive the air from the air outlet of the hopper and distribute the air to the grill rack.

14. The portable grill and smoker of claim 13, further comprising a lid covering the grill rack and the hopper.

15. The portable grill and smoker of claim 13, further comprising a controller configured to control a speed of the fan.

16. The portable grill and smoker of claim 13, further comprising a collapsible cart.

17. A portable grill and smoker, comprising:
a lower body;
a body liner configured to fit within an interior of the lower body, the body liner comprising a fuel-basket well and further comprising one or more supports configured to support a grill rack;
a fuel basket configured to fit within the fuel-basket well;
a fuel-grate assembly configured to fit within the fuel basket, the fuel-grate assembly comprising a fuel grate configured to hold fuel for generating at least one of heat or smoke in the portable grill and smoker, wherein the fuel basket and the fuel-grate assembly together form a hopper above the fuel grate and an ash collector below the fuel grate; and
a fan configured to provide both combustion air to the fuel grate and at least one of heated air or smoke to the grill rack.

18. The portable grill and smoker of claim 17, further comprising a controller configured to control a speed of the fan.
